(19) United States
(12) Patent Application Publication
(10) Pub. No.: US 2014/0237977 A1
(43) Pub. Date: Aug. 28, 2014

(54) CONVEYOR REGION BORDER FOR AN AGRICULTURAL HARVESTER, IN PARTICULAR A FORAGE HARVESTER

(71) Applicant: BETEK GMBH & CO. KG, Aichhalden (DE)

(72) Inventors: Pascal Detemple, Schramberg (DE); Florian Smeets, Baiersbronn (DE)

(21) Appl. No.: 14/351,506

(22) PCT Filed: Oct. 11, 2012
(86) PCT No.: PCT/EP2012/070189

§ 371 Date: Apr. 11, 2014

(30) Foreign Application Priority Data
Oct. 12, 2011 (DE) 10 2011 054 428.3

(51) Int. Cl. A01D 43/06

(52) U.S. Cl. CPC A01D 43/06
USPC 56/153

(57) ABSTRACT

A conveyor region border for an agricultural harvester, in particular a forage harvester, having a conveyor surface. This invention effectively protects such a conveyor region border against wear because wear protection elements are arranged on the conveyor surface in a mutually spaced manner, and the wear protection elements have a support part connected to the conveyor surface and a hard-material element directly or indirectly connected to the support part.

### BACKGROUND OF THE INVENTION

1. Field of the Invention

This invention relates to a conveyor region border for an agricultural harvester, particularly a forage harvester having a conveyor surface.

2. Discussion of Related Art

German Patent Reference DE 10 2010 004 648 A1 discloses a forage harvester that has an attachment connected to a motor-driven cutter head. The circumference of the cutter head is equipped with blades. The blades cooperate with a shear bar. The product to be harvested, for example corn, is supplied through the attachment and conveyed by a feed mechanism of the cutter head. The compression rollers of this feed mechanism compress the cut harvested product and feed it successively to the cutter head. The blades cooperate with the shear bar to cut pieces of the compressed crop to the desired chaffing size. The cutter head is associated with a friction base as a conveyor region border. The blades transport the cut chaffing material across the friction base. After the friction base, an additional friction strip, for example, can be provided, which forms a gradation between the friction base and the friction strip. At the friction strip, the blades chop the chaffing material smaller as needed. After the cutter head, the chaffing material is fed into an ascending ejection chute and can be fed out into the ejection chute via a conditioning unit and an accelerator unit. The friction base, which serves as a conveyor region border, is subject to powerful wear because this is where the cut chaffing material is transported in a highly compressed form across the conveying surface of the friction base. The wear is further increased by the soil material, such as sand, adhering to the harvested product.

### SUMMARY OF THE INVENTION

One object of this invention is to provide effective wear protection for a conveyor region border in an agricultural harvester, particularly a forage harvester.

This object is achieved if wear protection elements are situated spaced apart from each other on the conveyor surface and the wear protection elements have a supporting piece connected to the conveyor surface and a hard material element connected directly or indirectly to the supporting piece.

Between the wear protection elements, spacer regions are formed into which the harvested material is compressed. The outflow of harvested material in the direction of the supply flow is hindered by the wear protection elements. As a result, a layer forms that acts as a natural wear protection and protects the conveyor surface. The wear protection elements themselves have a hard material element that experiences only a small amount of wear, even when exposed to powerful abrasive stress. As a result, these anchor points for the wear protection layer composed of harvested product remain in place for a long time. The wear protection elements also have a supporting piece that is connected to the hard material element. This supporting piece is preferably of a material with good welding properties and thus is preferably welded to the conveyor surface.

If the wear protection elements are worn down, they can be removed from the conveyor surface and new wear protection elements can be attached, preferably by means of welding.

In order to achieve a uniform wear behavior, according to one embodiment of this invention, in at least some regions, the wear protection elements can be spaced apart from one another by the same spacing distance in a spacing pattern on the conveyor surface. This measure also ensures that there is no impediment to the uniform flow of material.

Particularly for harvesting conventional crops such as corn and the like, a spacing distance between the wear protection elements in the range between 5 mm and 70 mm facilitates a good conveying action.

In one embodiment of this invention, the wear protection elements are arranged in rows in at least some regions and the rows are spaced apart from one another. This spaced-apart arrangement of for example parallel rows is easy to install.

It is particularly preferable for the wear protection elements of at least two adjacent rows to be at least partially offset from each other. Then the wear protection elements constitute obstacles to the conveyed material and the interstices between the wear protection elements load up quickly and effectively. The obstacles also help or serve to break up the chopped harvested product better. This improves feed quality and improves quality in the process for producing biogas.

Particularly good results are achieved if the wear protection elements are offset from one another by half the spacing distance.

The rows of wear protection elements are advantageously aligned transversely, in particular perpendicularly, to the conveying direction, to prevent transverse force components from being introduced into the conveyed material during the conveying.

An effective wear protection and good breakdown properties can he achieved if the hard material element protrudes from the conveyor surface by at least 10 mm and at most 18 mm. The minimum protrusion ensures a sufficient wear length. The maximum protrusion of the hard material element prevents excessive stress on the connection point between the conveyor surface and the wear protection element.

In one embodiment of this invention, the supporting piece has a recessed socket for the hard material element, with a casing that encompasses at least part of the hard material element.

Preferably, a base part of the supporting piece is welded to the conveyor surface and in at least part of the transition region between the base part and the conveyor surface, a bead-shaped welding region is provided, which can be embodied in the form of a surrounding ring. The welding region protects the base part from erosion so that this measure extends the service life.

Concave conveyor surfaces can be effectively protected by the wear protection elements. With this shape of conveyor surface, particularly when a conveyor region border is used as a friction base in a forage harvester, radial force components are introduced into the harvested product, which encourages an effective loading-up of the interstices between the wear protection elements. It is thus possible to facilitate a high compression rate in the harvested product. The concave conveyor surface in this case can be continuous or discontinuous.

It is possible for the conveyor surface to be of slat-shaped segment components that are oriented at an angle to one another. This segmented, concave conveyor surface in particular features high rigidity properties.

It is also possible for each segment component to support one or more rows of wear protection elements in order to permit easy installation of the wear protection elements. The slat-shaped segment components can have a durable welded connection between the wear protection elements and the conveyor surface.

### BRIEF DESCRIPTION OF THE DRAWINGS

This invention is explained in greater detail below in view of an exemplary embodiment shown in the drawings, wherein:

FIG. 1 shows a top view of a friction base for a forage harvester, according to one embodiment of this invention;

FIG. 2 shows a front view of the friction base according to FIG. 1;

FIG. 3 shows a view of the cross-section labeled III-III in FIG. 1; and

FIG. 4 shows an enlarged-scale view of a detail labeled IV in FIG. 1.

### DETAILED DESCRIPTION OF THE INVENTION

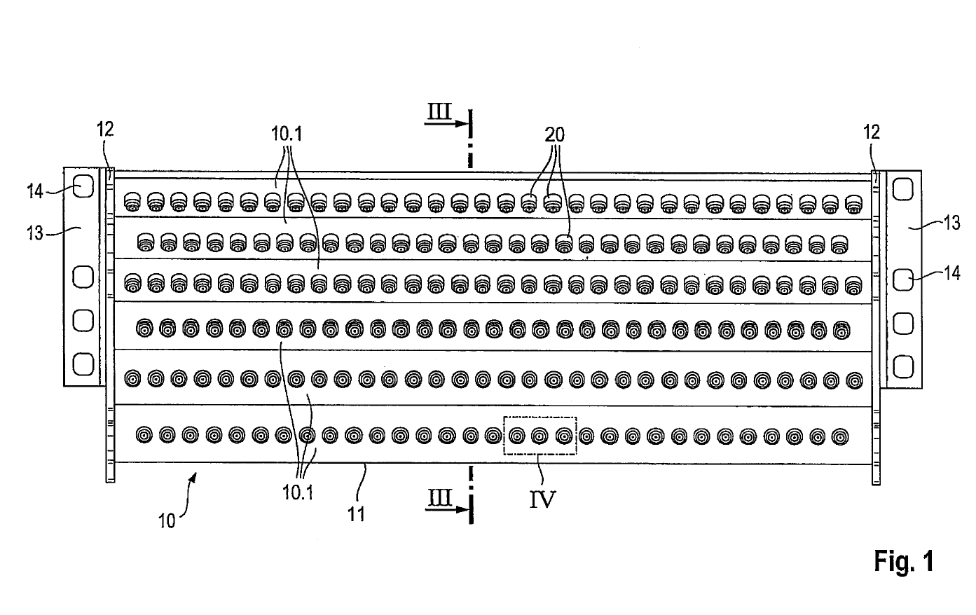

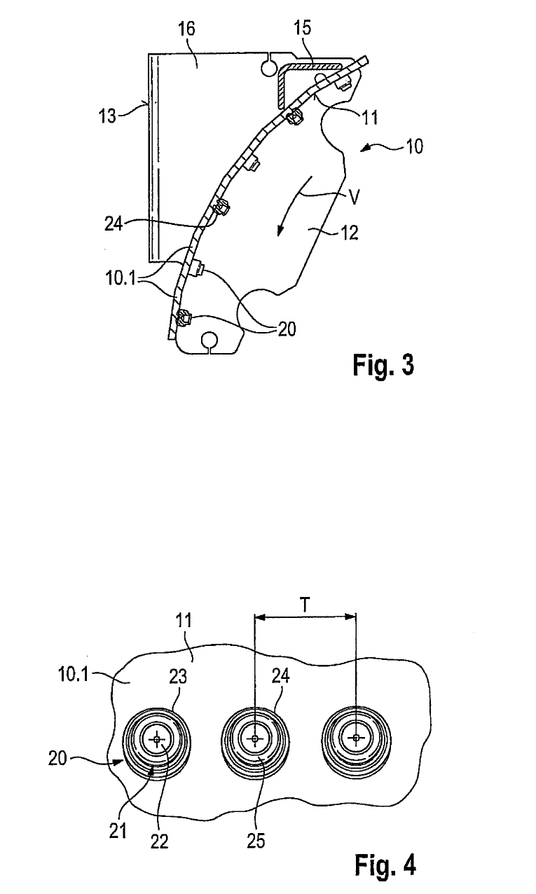

FIG. 1 shows a conveyor region border 10, namely a friction base, for a forage harvester. It has a concave conveyor surface 11 comprising or of six segment components. The segment components are embodied in the form of slat-shaped elements. As shown in FIG. 3, the individual segment components are oriented at an angle relative to one another. At the sides, the conveyor surface 11 is enclosed by two side pieces 12. The side pieces 12 define the sides of the conveyor path.

Supports 16 are integrally joined to the conveyor region border 10 to allow the friction base to be mounted in the housing of the forage harvester. As shown in FIGS. 1 and 3, flanges 13 with fastening openings 14 are angled in opposite directions from the supports 16. To stiffen the conveyor surface 11, angled elements 15 can be provided to support the rear of the conveyor region border 10.

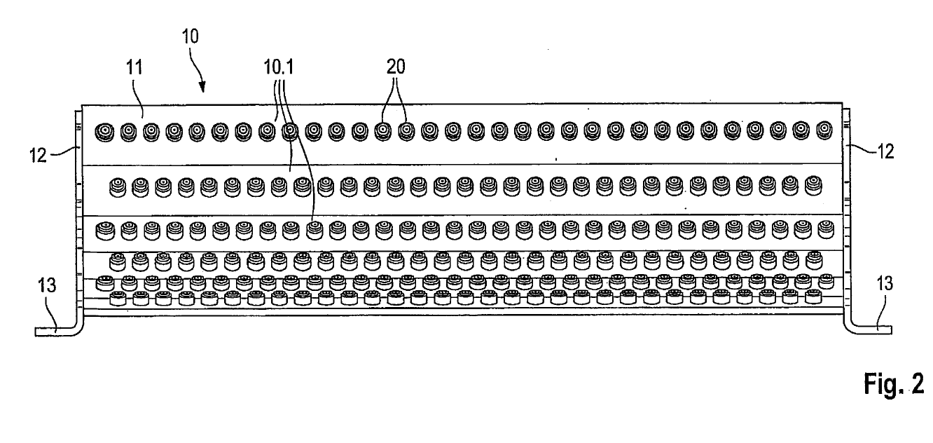

FIGS. 1 and 2 show how the conveyor surface 11 is covered with wear protection elements 20. FIGS. 3 and 4 show that the wear protection elements 20 have a supporting piece 21 comprising or of a support material such as steel that has good electrical conductivity and can be easily welded. The supporting piece 21 has a recessed socket that forms a circumferential casing piece 25. A hard material element 22, for example comprising or of hard metal or ceramic, is inserted into this socket. The hard metal element 22 can be affixed in the socket with material adhesion and/or form-fitting engagement and/or frictional, nonpositive engagement. For example, it can be brazed into the socket. The wear protection element 20 has a base part 24 that is attached to the conveyor surface 11 by a welded connection. The welded connection in this case is embodied so that the base part 24 is surrounded in a ring shape by a welding region 23. The welding region 23 protects the transition region between the base part 24 and the conveyor surface 11. In addition, a welded connection is provided that covers the area between the bottom of the wear protection element 20 and the top of the conveyor surface 11. Conventional stud welding methods can be used to produce this welded connection.

FIGS. 1 and 2 show that the wear protection elements are arranged spaced apart from one another and in rows. In this case, a uniform spacing distance T (see FIG. 3) is maintained between the individual wear protection elements 20. The adjacent rows of wear protection elements 20 are respectively offset by a half of the spacing distance, as is shown in FIG. 1.

During harvesting operation, the chaffing material is conveyed over the conveyor surface 11 in the feed direction V (see FIG. 3). The fibrous chaffing material accumulates in the regions between the wear protection elements 20 and is compacted in the spacing regions. As a result, the entire area of the conveyor surface 11 is loaded up with chafing material and constitutes or forms a natural wear protection.

1. A conveyor region border for an agricultural harvester, including a forage harvester, having a conveyor surface (11), comprising: wear protection elements (20) spaced apart from each other on the conveyor surface (11) and the wear protection elements (20) have a supporting piece (21) connected to the conveyor surface (11) and a hard material element (22) connected directly or indirectly to the supporting piece (21).

2. The conveyor region border according to claim 1, wherein in at least some regions the wear protection elements (20) are spaced apart from one another by a same spacing distance (T) in a spacing pattern on the conveyor surface (11).

3. The conveyor region border according to claim 2, wherein the spacing distance (T) is selected in a range between 5 mm and 70 mm.

4. The conveyor region border according to claim 3, wherein the wear protection elements (20) are arranged in rows in at least some regions and the rows are spaced apart from one another.

5. The conveyor region border according to claim 4, wherein the wear protection elements (20) of at least two adjacent rows are at least partially offset from each other.

6. The conveyor region border according to claim 5, wherein the wear protection elements (20) are offset from one another by a half of the spacing distance (T).

7. The conveyor region border according to claim 6, wherein the rows of wear protection elements (20) are aligned transversely to a conveying direction.

8. The conveyor region border according to claim 7, wherein the hard material element (22) protrudes from the conveyor surface (21) by at least 10 mm and/or at most 18 mm.

9. The conveyor region border according to claim 8, wherein the supporting piece (21) has a recessed socket for the hard material element (22) with a casing (25) that encompasses at least a part of the hard material element (22).

10. The conveyor region border according to claim 9, wherein a base part (24) of the supporting piece (21) is welded to the conveyor surface (11) and at least part of the transition region between the base part (24) and the conveyor surface (11) is covered by a bead-shaped welding region (23).

11. The conveyor region border according to claim 10, wherein the conveyor surface (11) is concave.

12. The conveyor region border according to claim 11, wherein the conveyor surface (11) is of slat-shaped segment components (10.1) oriented at an angle to one another.

13. The conveyor region border according to claim 12, wherein each segment component (10.1) supports one or more rows of wear protection elements (20).

14. The conveyor region border according to claim 1, wherein the wear protection elements (20) are arranged in rows in at least some regions and the rows are spaced apart from one another.

15. The conveyor region border according to claim 4, wherein the rows of wear protection elements (20) are aligned transversely to a conveying direction.

16. The conveyor region border according to claim 1, wherein the hard material element (22) protrudes from the conveyor surface (21) by at least 10 mm and/or at most 18 mm.

17. The conveyor region border according to claim 1, wherein the supporting piece (21) has a recessed socket for the hard material element (22) with a casing (25) that encompasses at least a part of the hard material element (22).

18. The conveyor region border according to claim 1, wherein a base part (24) of the supporting piece (21) is welded to the conveyor surface (11) and at least part of the transition region between the base part (24) and the conveyor surface (11) is covered by a bead-shaped welding region (23).

19. The conveyor region border according to claim 1, wherein the conveyor surface (11) is concave.
